(19) United States
(12) Patent Application Publication
(10) Pub. No.: US 2010/0266230 A1
(43) Pub. Date: Oct. 21, 2010

(54) ROTATING DEVICE INCLUDING A ROTATING SHAFT AND A SELF-LUBRICATING BEARING

(76) Inventor: Yin-Rong Hong, Kaohsiung City (TW)

Correspondence Address: FROMMER LAWRENCE & HAUG LLP, 745 FIFTH AVENUE, NEW YORK, NY, 10151, US

(21) Appl. No.: 12/559,591

(22) Filed: Sep. 15, 2009

(30) Foreign Application Priority Data
Apr. 20, 2009 (TW) 098112978

(51) Int. Cl. F16C 33/10

(52) U.S. Cl. 384/415

(57) ABSTRACT

A rotating device includes a rotating shaft rotatable in a rotational direction, and a self-lubricating bearing having an inner peripheral surface formed with a plurality of inclined ditches. Each of the inclined ditches has top and bottom ends, and extends downwardly from the top end to the bottom end in a direction corresponding to the rotational direction. The inner peripheral surface of the bearing has two outwardly diverging ends for preventing splashing of the lubricating oil from the top and bottom ends of the inclined ditches during rotation of the rotating shaft.

### CROSS-REFERENCE TO RELATED APPLICATION

This application claims priority of Taiwanese application No. 098112978, filed on Apr. 20, 2009.

### BACKGROUND OF THE INVENTION

1. Field of the Invention

This invention relates to a rotating device, and more particularly to a rotating device including a rotating shaft and a self-lubricating bearing, such as for use in a fan motor.

2. Description of the Related Art

It is necessary for a self-lubricating bearing to prevent escape of lubricating oil therefrom. Therefore, a conventional assembly of a rotating shaft and a self-lubricating bearing has been designed to be formed with a plurality of ditches for this purpose. For example, referring to FIG. 1, in a rotating device disclosed in Taiwanese Utility Model Patent No. 371019, contact surfaces of a self-lubricating bearing 11 and a rotating shaft 12 are formed with a plurality of helical ditches 13. In addition, referring to FIG. 2, in a rotating device disclosed in Taiwanese Utility Model Patent No. 517786, contact surfaces of a self-lubricating bearing 11 and a rotating shaft 12 are formed with a plurality of ditches 14, each of which has a top end open at a top surface of the self-lubricating bearing 11, and a closed bottom end disposed adjacent to a bottom surface of the self-lubricating bearing 11.

During rotation of the rotating shaft 12, the ditches 13, 14 can guide downward flow of the lubricating oil. However, the ditches 13, 14 are relatively long, thereby reducing the lubricating oil-guiding efficiency.

Furthermore, the diameter of an inner peripheral surface of the self-lubricating bearing 11 is uniform. As a result, the lubricating oil is apt to splash from two ends of the inner peripheral surface of the self-lubricating bearing 11 during rotation of the rotating shaft 12, thereby reducing the lubricating performance of the self-lubricating bearing 11.

### SUMMARY OF THE INVENTION

The object of this invention is to provide a rotating device that includes a rotating shaft and a self-lubricating bearing that is formed with a plurality of inclined ditches in an inner peripheral surface thereof so as to increase effectively the lubricating performance and the lubricating oil-guiding efficiency.

According to an aspect of this invention, there is provided a rotating device comprising:

a rotating shaft rotatable in a rotational direction; and
a self-lubricating bearing sleeved on the rotating shaft and having a top surface, a bottom surface, and an imaginary transverse line extending along a transverse direction of the rotating shaft for dividing the bearing into an upper bearing section and a lower bearing section disposed under the upper bearing section, an inner peripheral surface of the upper bearing section having an outwardly diverging upper end that increases gradually in diameter in a direction away from the transverse line, an inner peripheral surface of the lower bearing section having an outwardly diverging lower end that increases gradually in diameter in a direction away from the transverse line, the bearing being formed with a plurality of inclined ditches in at least one of the inner peripheral surfaces of the upper and lower bearing sections, each of the inclined ditches having top and bottom ends and extending downwardly from the top end to the bottom end in a direction corresponding to the rotational direction, the top and bottom ends of each of the inclined ditches being located between the top and bottom surface of the bearing and being spaced apart from each other by a vertical distance that is not larger than one half of a vertical length of the bearing.

According to another aspect of this invention, there is provided a rotating device comprising:

a rotating shaft rotatable in a rotational direction; and

a self-lubricating bearing sleeved on the rotating shaft and having a top surface, a bottom surface, and two imaginary transverse lines which are spaced apart from each other along an axial direction of the rotating shaft and each of which extends along a transverse direction of the rotating shaft for dividing the bearing into an upper bearing section, a middle bearing section, and a lower bearing section, which are three separate members and which are arranged along the axial direction of the rotating shaft, the middle bearing section being disposed under the upper bearing section and above the lower bearing section, each of the upper and lower bearing sections having a vertical length smaller than that of the middle bearing section, an inner peripheral surface of each of the upper and lower bearing sections having an outwardly diverging upper end that increases upwardly and gradually in diameter, and an outwardly diverging lower end that increases downwardly and gradually in diameter, the bearing being formed with:

an upper group of inclined ditches formed in the inner peripheral surface of the upper bearing section and located under the top surface of the bearing, the top ends of the upper group of the inclined ditches being open at the outwardly diverging upper end of the inner peripheral surface of the upper bearing section, the bottom ends of the upper group of the inclined ditches being open at the outwardly diverging lower end of the inner peripheral surface of the upper bearing section, and

a lower group of inclined ditches formed in the inner peripheral surface of the lower bearing section and located above the bottom surface of the bearing, the top ends of the lower group of the inclined ditches being open at the outwardly diverging upper end of the inner peripheral surface of the lower bearing section, the bottom ends of the lower group of the inclined ditches being open at the outwardly diverging lower end of the inner peripheral surface of the lower bearing section, each of the upper and lower groups of the inclined ditches having top and bottom ends and extending downwardly from the top end to the bottom end in a direction corresponding to the rotational direction, the top and bottom ends of each of the upper and lower groups of the inclined ditches being spaced apart from each other by a vertical distance that is not larger than one half of a vertical length of the bearing.

Since the extending direction of each of the inclined ditches from the top end to the bottom end corresponds to the rotational direction, the lubricating oil can flow easily in the inclined ditches.

Furthermore, due to the presence of the outwardly diverging upper and lower ends of the inner peripheral surface of the bearing, during rotation of the rotating shaft, splashing of the lubricating oil from the top and bottom ends of the inclined ditches can be diminished.

Further, since the vertical distance between the top and bottom ends of each of the inclined ditches is not larger than one half of the vertical length of the bearing, the lubricating oil-guiding efficiency of the inclined ditches can be increased.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a sectional side view of a rotating device disclosed in Taiwanese Utility Model Patent No. 371019;

FIG. 2 is a sectional side view of a rotating device disclosed in Taiwanese Utility Model Patent No. 517786;

FIG. 3 is an exploded perspective view of the first preferred embodiment of a rotating device according to this invention;

FIG. 4 is a partly cutaway perspective view of a self-lubricating bearing of the first preferred embodiment;

FIG. 5 is a fragmentary sectional side view of the first preferred embodiment; and

FIGS. 6 to 37 are fragmentary sectional side views of the second to thirty-third preferred embodiments, respectively.

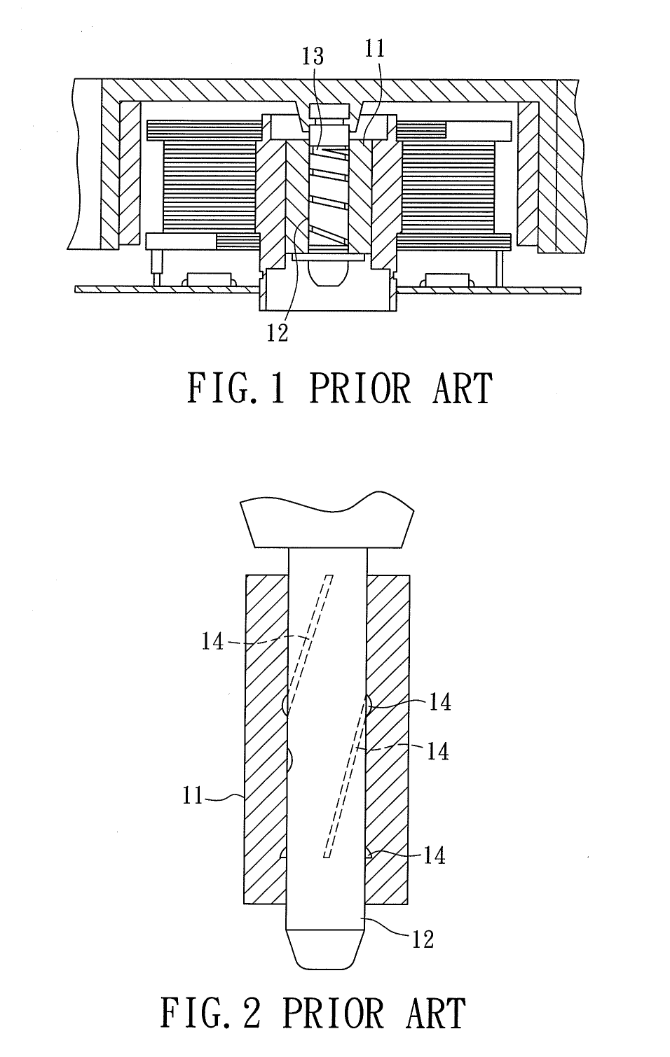

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

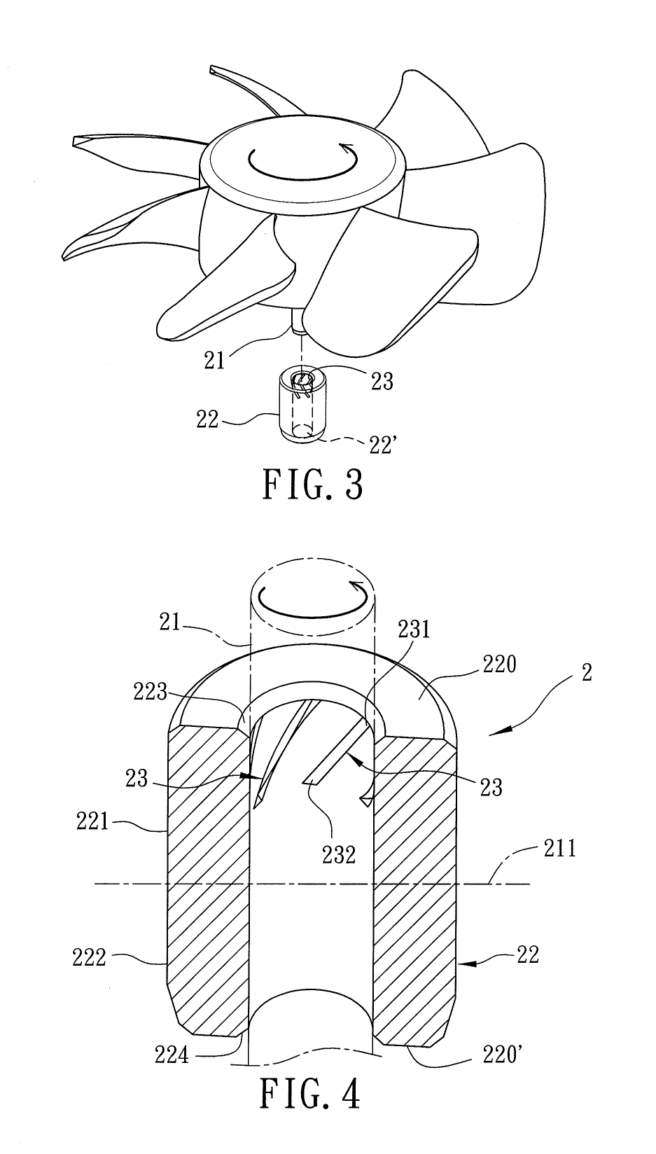

Referring to FIGS. 3, 4, and 5, the first preferred embodiment of a rotating device 2 according to this invention is used for a fan motor. The fan motor includes a plurality of components, such as a housing, a fan hub, a stator, a circuit board, etc. Since such components are well known in the art, they are not shown in the drawings, and a further description thereof will be omitted herein.

The rotating device 2 includes a rotating shaft 21 rotatable in a rotational direction (i.e., counterclockwise direction), and a self-lubricating bearing 22 sleeved on the rotating shaft 21. The bearing 22 is defined to have an imaginary transverse line 211 extending along a transverse direction of the rotating shaft 21 for dividing the bearing 22 into an upper bearing section 221 and a lower bearing section 222 disposed under the upper bearing section 221. An inner peripheral surface of the upper bearing section 221 has an outwardly diverging upper end 223 that increases gradually in diameter in a direction away from the transverse line 211. An inner peripheral surface of the lower bearing section 222 has an outwardly diverging lower end 224 that increase gradually in diameter in a direction away from the transverse line 211. The inner peripheral surfaces of the upper and lower bearing sections 221, 222 cooperate to define a central hole 22′ of the bearing 22. The upper and lower bearing sections 221, 222 are formed integrally with each other, and have the same vertical length. The bearing 22 is formed with a plurality of inclined ditches 23 in the inner peripheral surface of at least one of the upper and lower bearing sections 221, 222 and between top and bottom surfaces 220, 220′ of the bearing 22. In this embodiment, the inclined ditches 23 are formed in the inner peripheral surface of the upper bearing section 221.

Each of the inclined ditches 23 has top and bottom ends 231, 232, and extends downwardly from the top end 231 to the bottom end 232 in a direction corresponding to the rotational direction. The top ends 231 of the inclined ditches 23 are open at the outwardly diverging upper end of the inner peripheral surface of the upper bearing section 221. The bottom ends 232 of the inclined ditches 23 are located above the transverse line 211. As such, the top and bottom ends 231, 232 of each of the inclined ditches 23 are spaced apart from each other by a vertical distance that is not larger than one half of the vertical length of the bearing 22. In this embodiment, the distance between the top and bottom ends 231, 232 of each of the inclined ditches 23 is about one-third of the vertical length of the bearing 22.

Since the extending direction of each of the inclined ditches 23 from the top end 231 to the bottom end 232 corresponds to the rotational direction, the lubricating oil can flow easily in the inclined ditches 23.

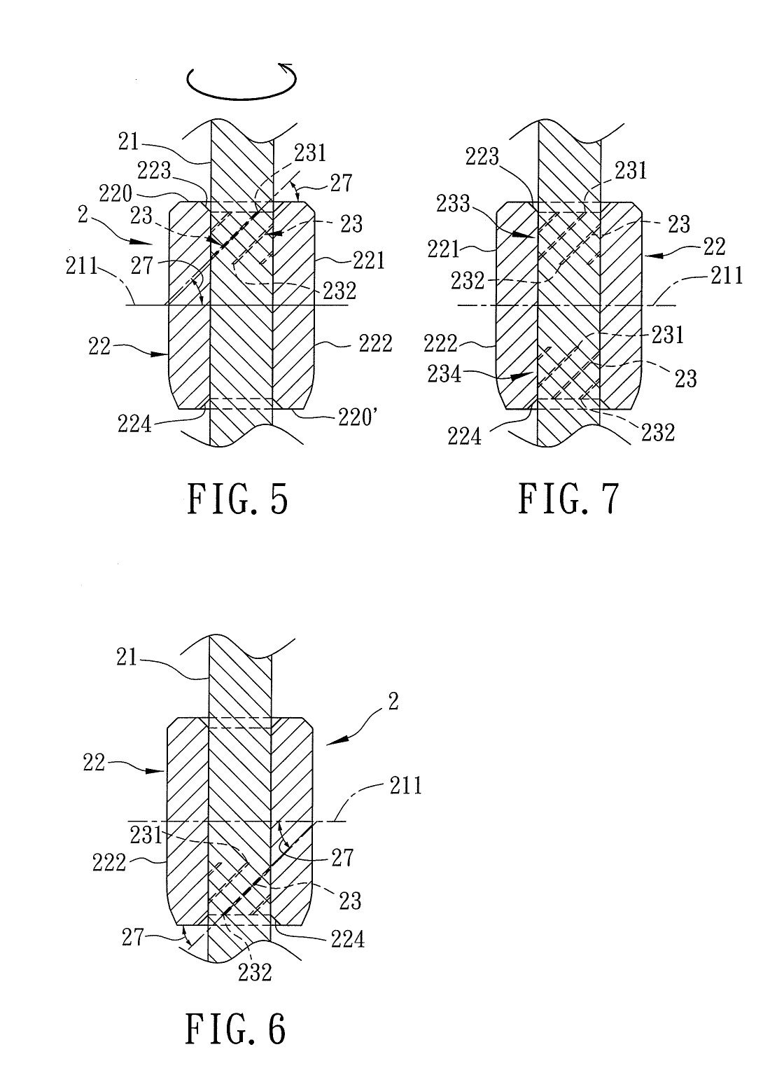

With particular reference to FIG. 5, each of the inclined ditches 23 forms an angle 27 with respect to the transverse line 211. If the angle 27 is smaller than 20 degrees, the lubricating oil will tend to flow horizontally, thereby affecting adversely flow of the lubricating oil in the inclined ditches 23. If the angle 27 is larger than 70 degrees, the lubricating oil will flow rapidly in the inclined ditches 23, thereby affecting adversely the lubricating effect. Thus, the angle 27 is preferably between 20 and 70 degrees.

Furthermore, due to the presence of the outwardly diverging upper and lower ends 223, 224 of the inner peripheral surface of the bearing 22, during rotation of the rotating shaft 21, splashing of the lubricating oil from the top and bottom ends 231, 232 of the inclined ditches 23 can be diminished.

Further, since the vertical distance between the top and bottom ends 231, 232 of each of the inclined ditches 23 is not larger than one half of the vertical length of the bearing 22, the lubricating oil-guiding efficiency of the inclined ditches 23 can be increased.

Other preferred embodiments described hereinafter are similar to the first preferred embodiment in the vertical distance between the top and bottom ends 231, 232 of each of the inclined ditches 23 and the extending direction of the inclined ditches 23.

FIG. 6 shows the second preferred embodiment, which differs from the first preferred embodiment shown in FIG. 5 in that the inclined ditches 23 are formed in the inner peripheral surface of the lower bearing section 222, such that the top ends 231 of the inclined ditches 23 are located under the transverse line 211, and the bottom ends 232 of the inclined ditches 23 are open at the outwardly diverging lower end 224 of the inner peripheral surface of the lower bearing section 222.

FIG. 7 shows the third preferred embodiment, which differs from the first preferred embodiment shown in FIG. 5 in that the inclined ditches 23 includes an upper group 233 of inclined ditches 23 formed in the inner peripheral surface of the upper bearing section 221, and a lower group 234 of inclined ditches 23 formed in the inner peripheral surface of the lower bearing section 222. The top ends 231 of the upper group 233 of inclined ditches 23 are open at the outwardly diverging upper end 223 of the inner peripheral surface of the upper bearing section 221. The bottom ends 232 of the upper group 233 of the inclined ditches 23 are closed, and are located above the transverse line 211. The top ends 231 of the lower group 234 of the inclined ditches 23 are closed, and are located under the transverse line 211. The bottom ends 232 of the lower group 234 of the inclined ditches 23 are open at the outwardly diverging lower end 224 of the inner peripheral surface of the lower bearing section 222.

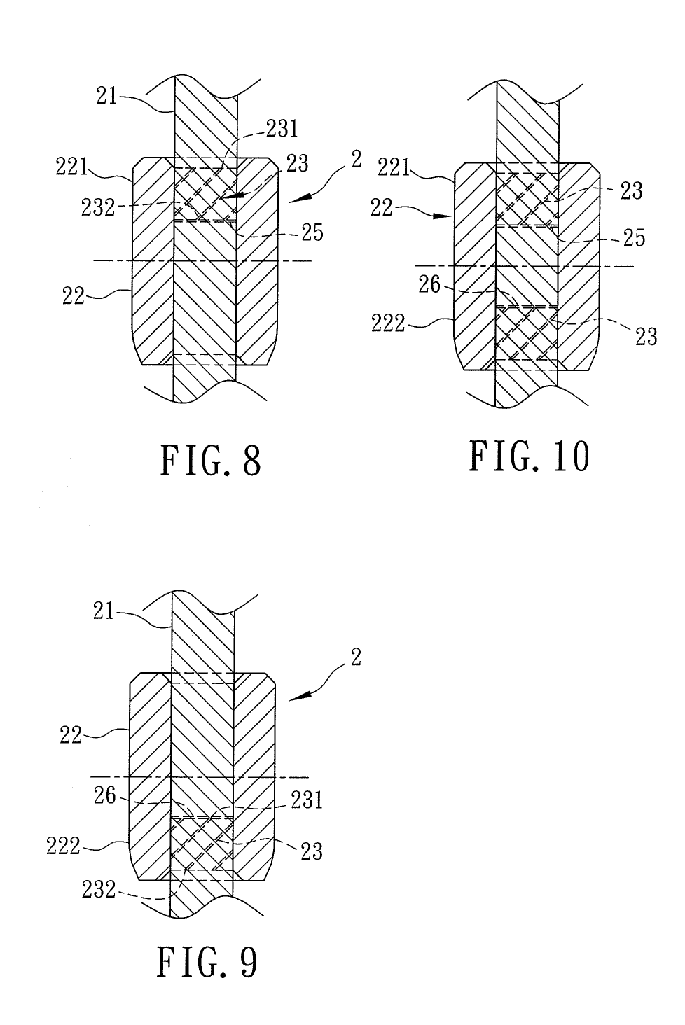

FIG. 8 shows the fourth preferred embodiment, which differs from the first preferred embodiment shown in FIG. 5 in that the bearing 22 is further formed with a bottom connecting trench 25. The bottom connecting trench 25 is formed in the inner peripheral surface of the upper bearing section 221, and is communicated with the bottom ends 232 of the inclined ditches 23.

FIG. 9 shows the fifth preferred embodiment, which differs from the second preferred embodiment shown in FIG. 6 in that the bearing 22 is further formed with a top connecting trench 26. The top connecting trench 26 is formed in the inner peripheral surface of the lower bearing section 222, and is communicated with the top ends 231 of the inclined ditches 23.

FIG. 10 shows the sixth preferred embodiment, which differs from the third preferred embodiment shown in FIG. 7 in that the bearing 22 is further formed with a bottom connecting trench 25 and a top connecting trench 26. The bottom connecting trench 25 is formed in the inner peripheral surface of the upper bearing section 221, and is communicated with the bottom ends 232 of the inclined ditches 23. The top connecting trench 26 is formed in the inner peripheral surface of the lower bearing section 222, and is communicated with the top ends 231 of the inclined ditches 23.

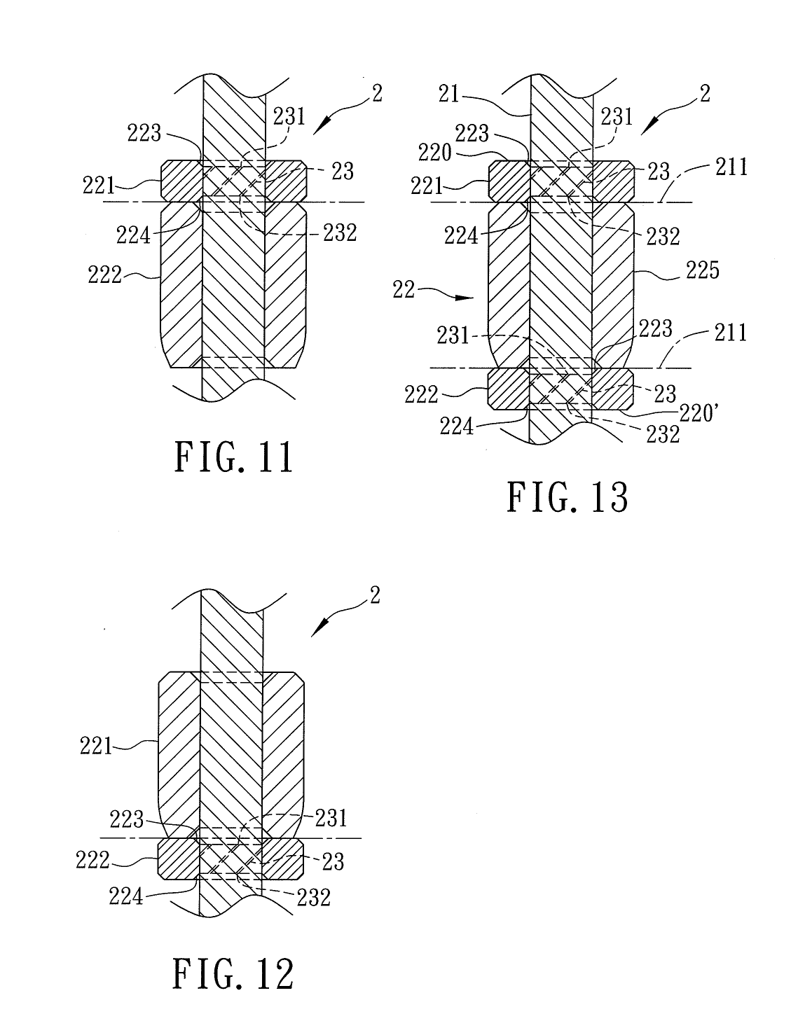

FIG. 11 shows the seventh preferred embodiment that is similar to the first preferred embodiment shown in FIG. 5. Unlike the first preferred embodiment, the upper and lower bearing sections 221, 222 are two separate members, and the upper bearing section 221 has a vertical length smaller than that of the lower bearing section 222. An inner peripheral surface of each of the upper and lower bearing sections 221, 222 has an outwardly diverging upper end 223 that increases upwardly and gradually in diameter, and an outwardly diverging lower end 224 that increases downwardly and gradually in diameter. In this embodiment, the inclined ditches 23 are formed in the inner peripheral surface of the upper bearing section 221. The top ends 231 of the inclined ditches 23 are open at the outwardly diverging upper end 223 of the inner peripheral surface of the upper bearing section 221. The bottom ends 232 of the inclined ditches 23 are open at the outwardly diverging lower end 224 of the inner peripheral surface of the upper bearing section 221.

FIG. 12 shows the eighth preferred embodiment, which differs from the seventh preferred embodiment shown in FIG. 11 in that the inclined ditches 23 are formed in the inner peripheral surface of the lower bearing section 222 instead of the upper bearing section 221, and the lower bearing section 222 has a vertical distance smaller than that of the upper bearing section 221. The top ends 231 of the inclined ditches 23 are open at the outwardly diverging upper end 223 of the inner peripheral surface of the lower bearing section 222. The bottom ends 232 of the inclined ditches 23 are open at the outwardly diverging lower end 224 of the inner peripheral surface of the lower bearing section 222.

FIG. 13 shows the ninth preferred embodiment, which differs from the seventh preferred embodiment shown in FIG. 11 in that the bearing 22 has two imaginary transverse lines 211, which are spaced apart from each other along an axial direction of the rotating shaft 21 and each of which extends along a transverse direction of the rotating shaft 21 for dividing the bearing 22 into an upper bearing section 221, a middle bearing section 225, and a lower bearing section 222. The upper, middle, and lower bearing sections 221, 225, 222 are three separate members, and are arranged along the axial direction of the rotating shaft 21. The middle bearing section 225 is disposed under the upper bearing section 221 and above the lower bearing section 222. Each of the upper and lower bearing sections 221, 222 has a vertical length smaller than that of the middle bearing section 225. An inner peripheral surface of each of the upper, middle, and lower bearing sections 221, 225, 222 has an outwardly diverging upper end 223 that increases upwardly and gradually in diameter, and an outwardly diverging lower end 224 that increases downwardly and gradually in diameter. The bearing 22 is formed with an upper group of inclined ditches 23 formed in the inner peripheral surface of the upper bearing section 221 and located under a top surface 220 of the bearing 22, and a lower group of inclined ditches 23 formed in the inner peripheral surface of the lower bearing section 222 and located above a bottom surface 220′ of the bearing 22. Each of the upper and lower groups of the inclined ditches 23 has top and bottom ends 231, 232, and extends downwardly from the top end 231 to the bottom end 232 in a direction corresponding to the rotational direction. The top ends 231 of the upper group of the inclined ditches 23 are open at the outwardly diverging upper end 223 of the inner peripheral surface of the upper bearing section 221. The bottom ends 232 of the upper group of the inclined ditches 23 are open at the outwardly diverging lower ends 224 of the inner peripheral surface of the upper bearing section 221. The top ends 231 of the lower group of the inclined ditches 23 are open at the outwardly diverging upper end 223 of the inner peripheral surface of the lower bearing section 222. The bottom ends 232 of the lower group of the inclined ditches 23 are open at the outwardly diverging lower end 224 of the inner peripheral surface of the lower bearing section 222. As such, the top and bottom ends 231, 232 of each of the upper and lower groups of the inclined ditches 23 are spaced apart from each other by a vertical distance that is not larger than one half of a vertical length of the bearing 22.

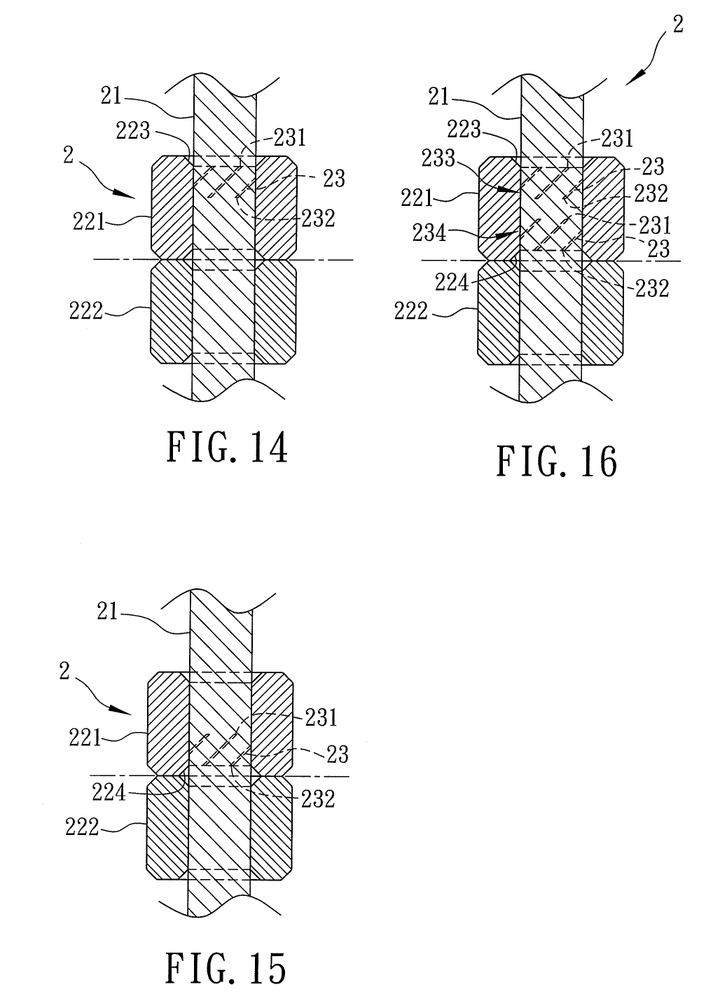

FIG. 14 shows the tenth preferred embodiment, which differs from the seventh preferred embodiment shown in FIG. 11 in that the upper and lower bearing sections 221, 222 have the same vertical length. In this embodiment, the top ends 231 of the inclined ditches 23 are open at the outwardly diverging upper end 223 of the inner peripheral surface of the upper bearing section 221, and the bottom ends 232 of the inclined ditches 23 are closed.

FIG. 15 shows the eleventh preferred embodiment, which differs from the tenth preferred embodiment shown in FIG. 14 in that the top ends 231 of the inclined ditches 23 are closed, and the bottom ends 232 of the inclined ditches 23 are open at the outwardly diverging lower end 224 of the inner peripheral surface of the upper bearing section 221.

FIG. 16 shows the twelfth preferred embodiment, which differs from the tenth preferred embodiment shown in FIG. 14 in that the inclined ditches 23 includes an upper group 233 of the inclined ditches 23 adjacent to an upper end of the upper bearing section 221, and a lower group 234 of the inclined ditches 23 adjacent to a lower end of the upper bearing section 221. The top ends 231 of the upper group 233 of the inclined ditches 23 are open at the outwardly diverging upper end 223 of the inner peripheral surface of the upper bearing section 221. The bottom ends 232 of the upper group 233 of the inclined ditches 23 are closed. The top ends 231 of the lower group 234 of the inclined ditches 23 are closed. The bottom ends 232 of the lower group 234 of the inclined ditches 23 are open at the outwardly diverging lower end 224 of the inner peripheral surface of the upper bearing section 221.

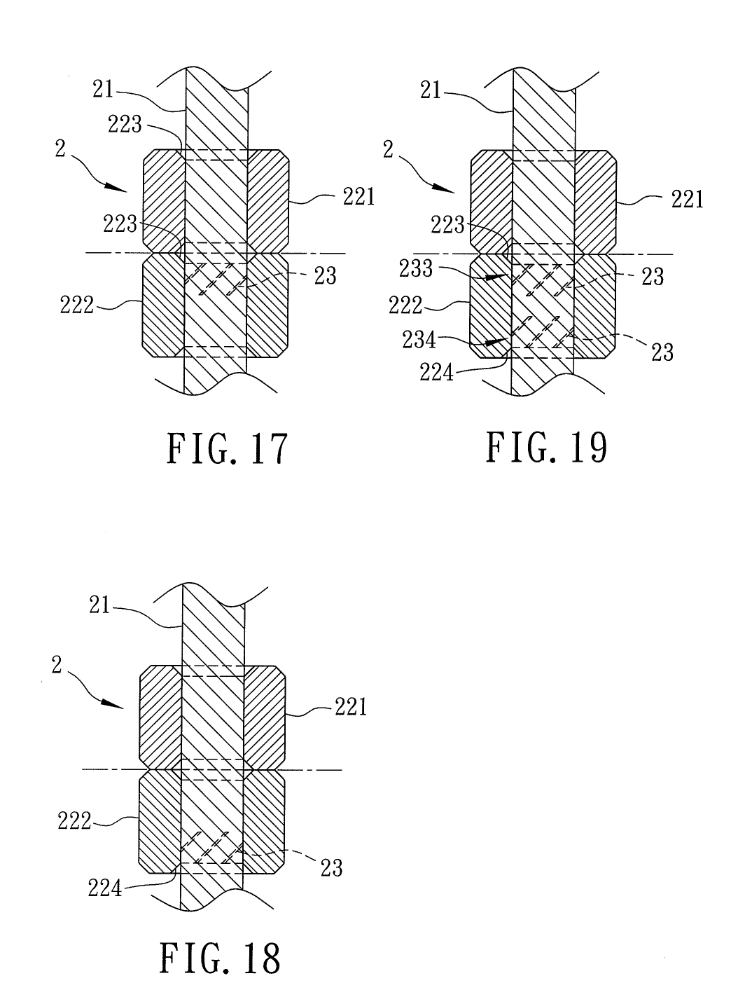

FIG. 17 shows the thirteenth preferred embodiment, which is similar to the tenth preferred embodiment shown in FIG. 14 except that the inclined ditches 23 are formed in the inner peripheral surface of the lower bearing section 222. The top ends 231 of the inclined ditches 23 are open at the outwardly diverging upper end 223 of the inner peripheral surface of the lower bearing section 222, and the bottom ends 232 of the inclined ditches 23 are closed.

FIG. 18 shows the fourteenth preferred embodiment, which is similar to the eleventh preferred embodiment shown in FIG. 15 except that the inclined ditches 23 are formed in the inner peripheral surface of the lower bearing section 222. The top ends 231 of the inclined ditches 23 are closed, and the bottom ends 232 of the inclined ditches 23 are open at the outwardly diverging lower end 224 of the inner peripheral surface of the lower bearing section 222.

FIG. 19 shows the fifteenth preferred embodiment, which is similar to the twelfth preferred embodiment shown in FIG. 16 except that the inclined ditches 23 the inclined ditches 23 are formed in the inner peripheral surface of the lower bearing section 222. The inclined ditches 23 includes an upper group 233 of the inclined ditches 23 adjacent to an upper end of the lower bearing section 222, and a lower group 234 of the inclined ditches 23 adjacent to a lower end of the lower bearing section 222. The top ends 231 of the upper group 233 of the inclined ditches 23 are open at the outwardly diverging upper end 223 of the inner peripheral surface of the lower bearing section 222. The bottom ends 232 of the upper group 233 of the inclined ditches 23 are closed. The top ends 231 of the lower group 234 of the inclined ditches 23 are closed. The bottom ends 232 of the lower group 234 of the inclined ditches 23 are open at the outwardly diverging lower end 224 of the inner peripheral surface of the lower bearing section 222.

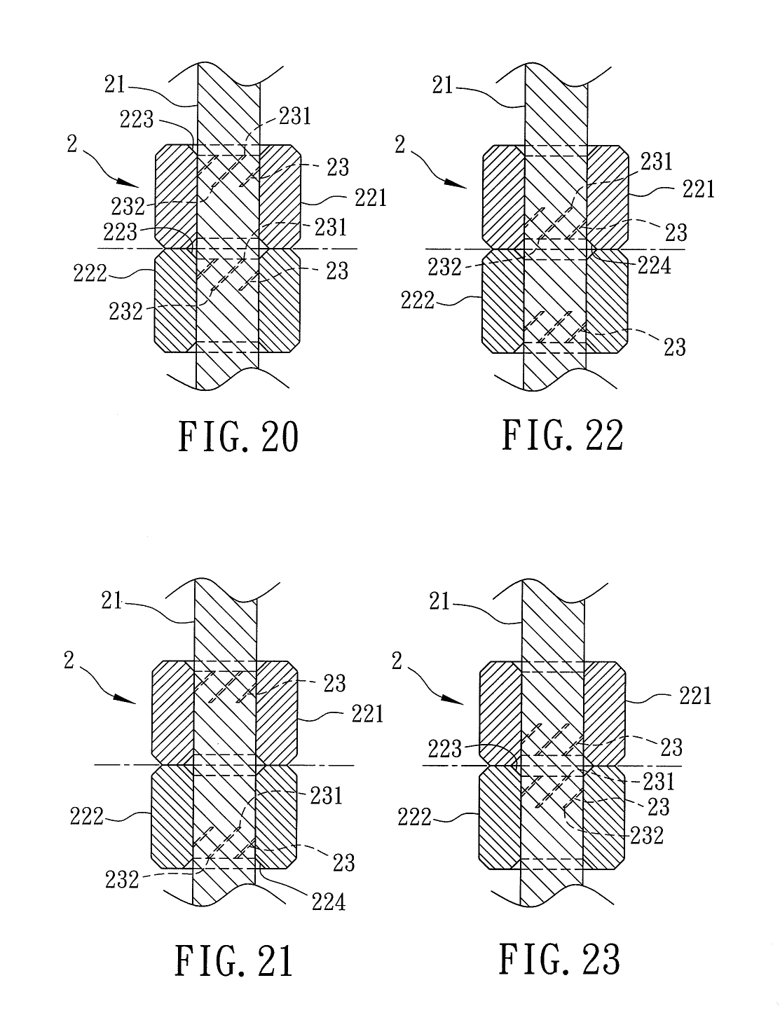

FIG. 20 shows the sixteenth preferred embodiment, which differs from the tenth preferred embodiment shown in FIG. 14 in that the inclined ditches 23 includes an upper group of the inclined ditches 23 formed in the inner peripheral surface of the upper bearing section 221, and a lower group of the inclined ditches 23 formed in the inner peripheral surface of the lower bearing section 222. The top ends 231 of the upper group of the inclined ditches 23 are open at the outwardly diverging upper end 223 of the inner peripheral surface of the upper bearing section 221. The bottom ends 232 of the upper group of the inclined ditches 23 are closed. The top ends 231 of the lower group of the inclined ditches 23 are open at the outwardly diverging upper end 223 of the inner peripheral surface of the lower bearing section 222. The bottom ends 232 of the lower group of the inclined ditches 23 are closed.

FIG. 21 shows the seventeenth preferred embodiment, which differs from the sixteenth preferred embodiment shown in FIG. 20 in that the top ends 231 of the lower group of the inclined ditches 23 are closed, and the bottom ends 232 of the lower group of the inclined ditches 23 are open at the outwardly diverging lower end 224 of the inner peripheral surface of the lower bearing section 222.

FIG. 22 shows the eighteenth preferred embodiment, which differs from the seventeenth preferred embodiment shown in FIG. 21 in that the top ends 231 of the upper group of the inclined ditches 23 are closed, and the bottom ends 232 of the upper group of the inclined ditches 23 are open at the outwardly diverging lower end 224 of the inner peripheral surface of the upper bearing section 221.

FIG. 23 shows the nineteenth preferred embodiment, which differs from the eighteenth preferred embodiment shown in FIG. 22 in that the top ends 231 of the lower group of the inclined ditches 23 are open at the outwardly diverging upper end 223 of the inner peripheral surface of the lower beating section 222, and the bottom ends 232 of the lower group of the inclined ditches 23 are closed.

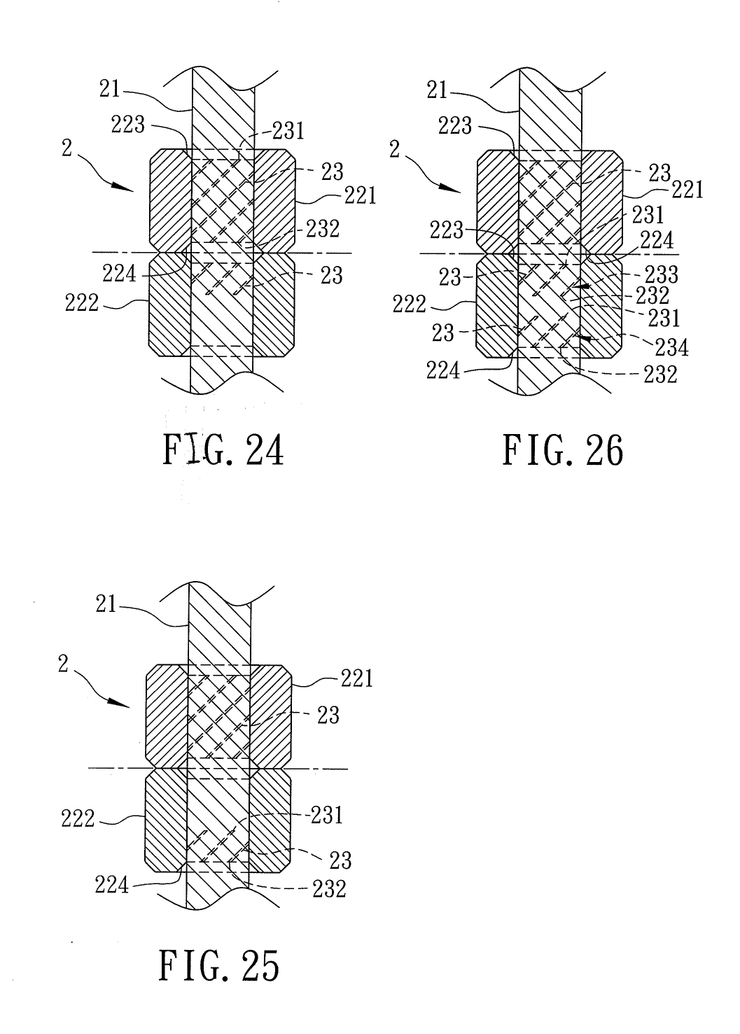

FIG. 24 shows the twentieth preferred embodiment, which differs from the sixteenth preferred embodiment shown in FIG. 20 in that the bottom ends 232 of the upper group of the inclined ditches 23 are open at the outwardly diverging lower end 224 of the inner peripheral surface of the upper bearing section 221.

FIG. 25 shows the twenty-first preferred embodiment, which differs from the twentieth preferred embodiment shown in FIG. 24 in that the top ends 231 of the lower group of the inclined ditches 23 are closed, and the bottom ends 232 of the lower group of the inclined ditches 23 are open at the outwardly diverging lower end 224 of the inner peripheral surface of the lower bearing section 222.

FIG. 26 shows the twenty-second preferred embodiment, which differs from the tenth preferred embodiment shown in FIG. 14 in arrangement of the inclined ditches 23. In this embodiment, the inclined ditches 23 are formed in the inner peripheral surfaces of the upper and lower bearing sections 221, 222. The top ends 231 of the inclined ditches 23 formed in the inner peripheral surface of the upper bearing section 221 are open at the outwardly diverging upper end 223 of the inner peripheral surface of the upper bearing section 221. The bottom ends 232 of the inclined ditches 23 formed in the inner peripheral surface of the upper bearing section 221 are open at the outwardly diverging lower end 224 of the upper bearing section 221. The inclined ditches 23 formed in the inner peripheral surface of the lower bearing section 222 includes an upper group 233 of the inclined ditches 23 adjacent to an upper end of the lower bearing section 222, and a lower group 234 of the inclined ditches 23 adjacent to a lower end of the lower bearing section 222. The top ends 231 of the upper group 233 of the inclined ditches 23 are open at the outwardly diverging upper end 223 of the inner peripheral surface of the lower bearing section 222. The bottom ends 232 of the upper group 233 of the inclined ditches 23 are closed. The top ends 231 of the lower group 234 of the inclined ditches 23 are closed. The bottom ends 232 of the lower group 234 of the inclined ditches 23 are open at the outwardly diverging lower end 224 of the inner peripheral surface of the lower bearing section 222.

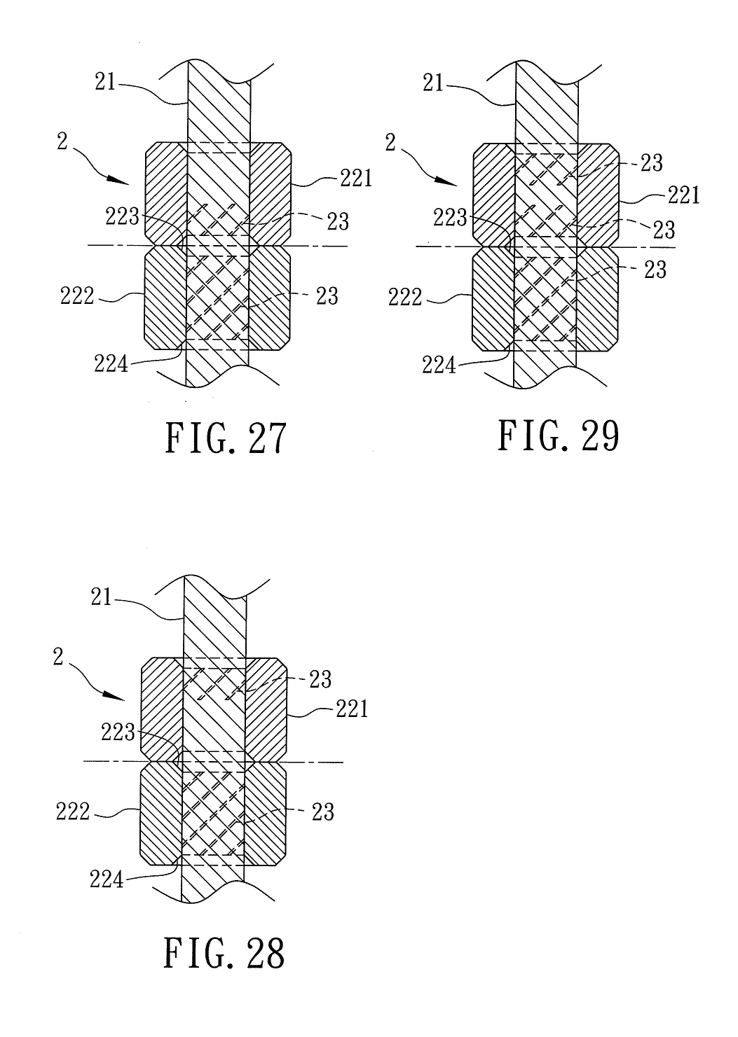

FIGS. 27, 28, and 29 show respectively the twenty-third, twenty-fourth, and twenty-fifth preferred embodiments, which differ respectively from the eleventh, tenth, and twelfth preferred embodiments shown in FIGS. 15, 14, 16 in that the inclined ditches 23 are also formed in the inner peripheral surface of the lower bearing section 222. In these three embodiments, the top ends 231 of the inclined ditches 23 formed in the inner peripheral surface of the lower bearing section 222 are open at the outwardly diverging upper end 223 of the inner peripheral surface of the lower bearing section 222. The bottom ends 232 of the inclined ditches 23 formed in the inner peripheral surface of the lower bearing section 222 are open at the outwardly diverging lower end 224 of the inner peripheral surface of the lower bearing section 222.

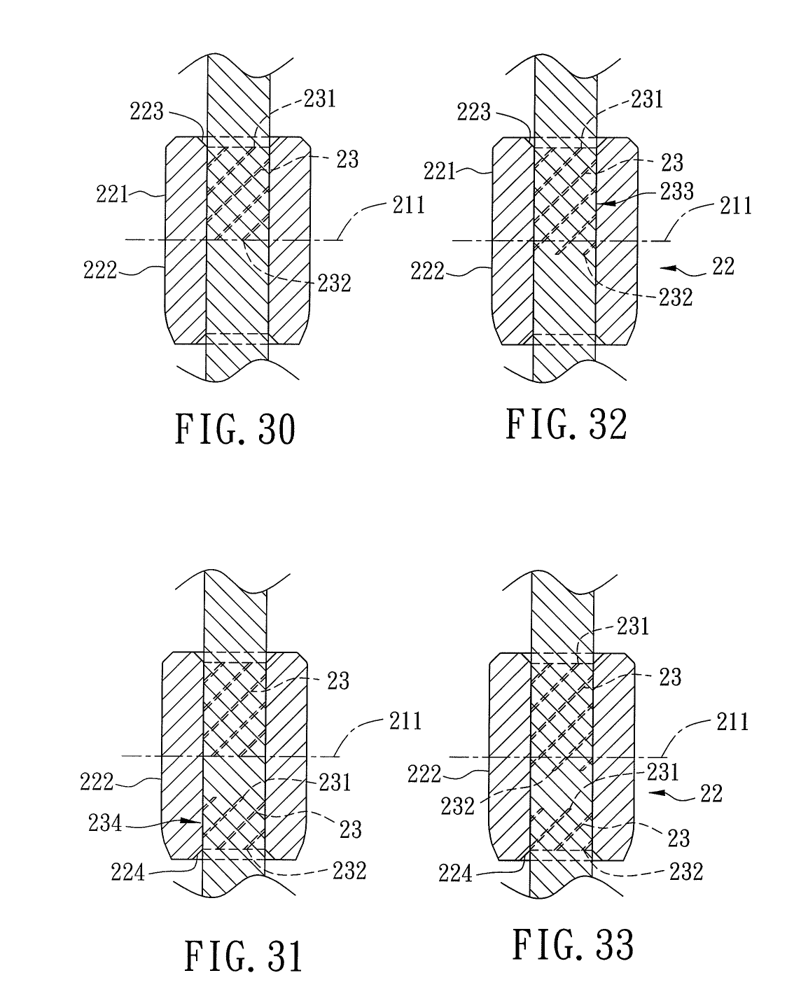

FIG. 30 shows the twenty-sixth preferred embodiment. Similar to the first preferred embodiment shown in FIG. 5, the upper and lower bearing sections 221, 222 are formed integrally with each other. Unlike the first preferred embodiment, the bottom ends 232 of the inclined ditches 23 are located on the transverse line 211.

FIG. 31 shows the twenty-seventh preferred embodiment, which differs from the twenty-sixth preferred embodiment shown in FIG. 30 in that the inclined ditches 23 are also formed in the inner peripheral surface of the lower bearing section 222. The top ends 231 of the inclined ditches 23 formed in lower bearing section 222 are closed. The bottom ends 232 of the inclined ditches 23 formed in the inner peripheral surface of the lower bearing section 222 are open at the outwardly diverging lower end 224 of the inner peripheral surface of the lower bearing section 222.

FIG. 32 shows the twenty-eighth preferred embodiment, which differs from the twenty-sixth preferred embodiment shown in FIG. 30 in that the bottom ends 232 of the inclined ditches 23 are located under the transverse line 211. As such, the inclined ditches 23 extend from the upper bearing section 221 into the lower bearing section 222. In this embodiment, since the distance between the transverse line 211 and the bottom ends 232 of the inclined ditches 23 is approximate to the vertical length of the outwardly diverging upper end 223 of the inner peripheral surface of the upper bearing section 221, the vertical distance between the top and bottom ends 231, 232 of each of the inclined ditches 23 is not larger than one half of the vertical length of the bearing 22.

FIG. 33 shows the twenty-ninth preferred embodiment, which is similar to the twenty-eighth preferred embodiment shown in FIG. 32. In this embodiment, the inclined ditches 23 includes an upper group of the inclined ditches 23 arranged in the same manner as the inclined ditches 23 in the twenty-eighth preferred embodiment, and a lower group of the inclined ditches 23 formed in the inner peripheral surface of the lower bearing section 222. In this embodiment, the top ends 231 of the lower group of the inclined ditches 23 are closed. The bottom ends 232 of the lower group of the inclined ditches 23 are open at the outwardly diverging lower end 224 of the inner peripheral surface of the lower bearing section 222.

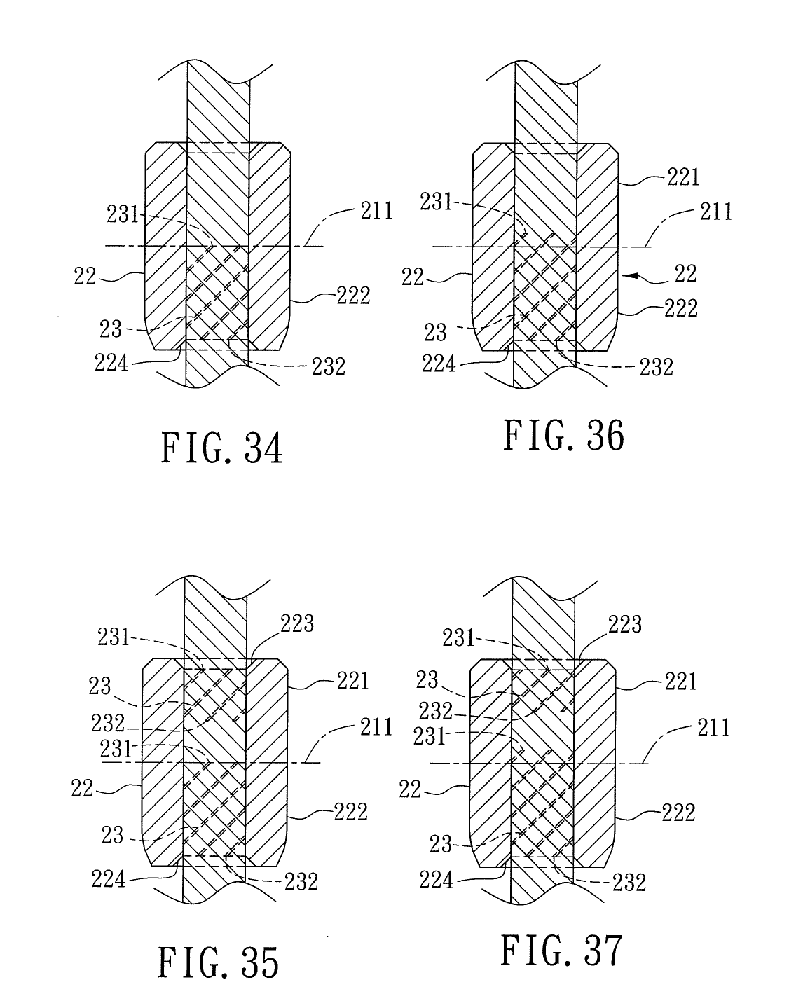

FIG. 34 shows the thirtieth preferred embodiment, which differs from the twenty-sixth preferred embodiment shown in FIG. 30 in the arrangement of the inclined ditches 23.

In this embodiment, the inclined ditches 23 are formed in the inner peripheral surface of the lower bearing section 222. The top ends 231 of the inclined ditches 23 are closed, and are located on the transverse line 211. The bottom ends 232 of the inclined ditches 23 are open at the outwardly diverging lower end 224 of the inner peripheral surface of the lower bearing section 222.

FIG. 35 shows the thirty-first preferred embodiment, which differs from the twenty-sixth preferred embodiment shown in FIG. 30 in the arrangement of the inclined ditches 23. In this embodiment, the inclined ditches 23 includes an upper group of the inclined ditches 23 formed in the inner peripheral surface of the upper bearing section 221, and a lower group of the inclined ditches 23 formed in the inner peripheral surface of the lower bearing section 222. The top ends 231 of the upper group of the inclined ditches 23 are open at the outwardly diverging upper end 223 of the inner peripheral surface of the upper bearing section 221. The bottom ends 232 of the upper group of the inclined ditches 23 are closed, and are located above the transverse line 211. The top ends 231 of the lower group of the inclined ditches 23 are closed, and are located on the transverse line 211. The bottom ends 232 of the lower group of the inclined ditches 23 are open at the outwardly diverging lower end 224 of the inner peripheral surface of the lower bearing section 222.

FIG. 36 shows the thirty-second preferred embodiment, which differs from the twenty-sixth preferred embodiment shown in FIG. 30 in the arrangement of the inclined ditches 23. In this embodiment, the inclined ditches 23 extend from the upper bearing section 221 into the lower bearing section 222. The top ends 231 of the inclined ditches 23 are closed, and are located above the transverse line 211. The bottom ends 232 of the inclined ditches 23 are open at the outwardly diverging lower end 224 of the inner peripheral surface of the lower bearing section 222. In this embodiment, since the distance between the transverse line 211 and the top ends 231 of the inclined ditches 23 is approximate to the vertical length of the outwardly diverging lower end 224 of the inner peripheral surface of the lower bearing section 222, the vertical distance between the top and bottom ends 231, 232 of each of the inclined ditches 23 is not larger than one half of the vertical length of the bearing 22.

FIG. 37 shows the thirty-third preferred embodiment, which differs from the twenty-sixth preferred embodiment shown in FIG. 30 in the arrangement of the inclined ditches 23. In this embodiment, the inclined ditches 23 includes an upper group of the inclined ditches 23 formed in the inner peripheral surface of the upper bearing section 221, and a lower group of the inclined ditches 23 extending from the upper bearing section 221 into the lower bearing section 222. The top ends 231 of the upper group of the inclined ditches 23 are open at the outwardly diverging upper end 223 of the inner peripheral surface of the upper bearing section 221. The bottom ends 232 of the upper group of the inclined ditches 23 are closed, and are located above the transverse line 211. The top ends 231 of the lower group of the inclined ditches 23 are closed, and are located above the transverse line 211. The bottom ends 232 of the lower group of the inclined ditches 23 are open at the outwardly diverging lower end 224 of the inner peripheral surface of the lower bearing section 222.

With this invention thus explained, it is apparent that numerous modifications and variations can be made without departing from the scope and spirit of this invention. It is therefore intended that this invention be limited only as indicated by the appended claims.

I claim:

1. A rotating device comprising:
a rotating shaft rotatable in a rotational direction; and
a self-lubricating bearing sleeved on said rotating shaft and having a top surface, a bottom surface, and an imaginary transverse line extending along a transverse direction of said rotating shaft for dividing said bearing into an upper bearing section and a lower bearing section disposed under said upper bearing section, an inner peripheral surface of said upper bearing section having an outwardly diverging upper end that increases gradually in diameter in a direction away from said transverse line, an inner peripheral surface of said lower bearing section having an outwardly diverging lower end that increases gradually in diameter in a direction away from said transverse line, said bearing being formed with a plurality of inclined ditches in at least one of said inner peripheral surfaces of said upper and lower bearing sections, each of said inclined ditches having top and bottom ends and extending downwardly from said top end to said bottom end in a direction corresponding to said rotational direction, said top and bottom ends of each of said inclined ditches being located between said top and bottom surfaces of said bearing and being spaced apart from each other by a vertical distance that is not larger than one half of a vertical length of said bearing.

2. The rotating device as claimed in claim 1, wherein said inclined ditches are formed in said inner peripheral surface of said upper bearing section, said top ends of said inclined ditches being open at said outwardly diverging upper end of said inner peripheral surface of said upper bearing section, said bottom ends of said inclined ditches being closed and located above said transverse line.

3. The rotating device as claimed in claim 2, wherein said bearing is further formed with a bottom connecting trench, said bottom connecting trench being formed in said inner peripheral surface of said upper bearing section and being communicated with said bottom ends of said inclined ditches.

4. The rotating device as claimed in claim 1, wherein said inclined ditches are formed in said inner peripheral surface of said lower bearing section, said top ends of said inclined ditches being closed and located under said transverse line, said bottom ends of said inclined ditches being open at said outwardly diverging lower end of said inner peripheral surface of said lower bearing section.

5. The rotating device as claimed in claim 4, wherein said bearing is further formed with a top connecting trench, said top connecting trench being formed in said inner peripheral surface of said lower bearing section and being communicated with said top ends of said inclined ditches.

6. The rotating device as claimed in claim 1, wherein each of said inclined ditches forms an angle between 20 and 70 degrees with respect to said transverse line.

7. The rotating device as claimed in claim 6, wherein said upper and lower bearing sections are formed integrally with each other, and have the same vertical length.

8. The rotating device as claimed in claim 1, wherein said inclined ditches includes:
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being closed and located above said transverse line, and
a lower group of said inclined ditches formed in said inner peripheral surface of said lower bearing section, said top ends of said lower group of said inclined ditches being closed and located under said transverse line, said bottom ends of said lower group of said inclined ditches being open at said outwardly diverging lower end of said inner peripheral surface of said lower bearing section.

9. The rotating device as claimed in claim 8, wherein said bearing is further formed with a bottom connecting trench and a bottom connecting trench, said bottom connecting trench being formed in said inner peripheral surface of said upper bearing section and being communicated with said bottom ends of said upper group of said inclined ditches, said top connecting trench being formed in said inner peripheral surface of said lower bearing section and being communicated with said top ends of said lower group of said inclined ditches.

10. The rotating device as claimed in claim 8, wherein each of said upper and lower groups of said inclined ditches forms an angle between 20 and 70 degrees with respect to said transverse line, said upper and lower bearing sections being formed integrally with each other and having the same vertical length.

11. The rotating device as claimed in claim 1, wherein:
said upper and lower bearing sections are two separate members;
said upper bearing section has a vertical length smaller than that of said lower bearing section;
said inner peripheral surface of said upper bearing section further has an outwardly diverging lower end that increases downwardly and gradually in diameter, and
said inclined ditches are formed in said inner peripheral surface of said upper bearing section, said top ends of said inclined ditches being open at said outwardly diverging upper end of said inner peripheral surface of said upper bearing section, said bottom ends of said inclined ditches being open at said outwardly diverging lower end of said inner peripheral surface of said upper bearing section.

12. The rotating device as claimed in claim 1, wherein:
said upper and lower bearing sections are two separate members;
said lower bearing section has a vertical length smaller than that of said upper bearing section;
said inner peripheral surface of said lower bearing section further has an outwardly diverging upper end that increases upwardly and gradually in diameter;
said inclined ditches is formed in said inner peripheral surface of said lower bearing section, said top ends of said inclined ditches being open at said outwardly diverging upper end of said inner peripheral surface of said lower bearing section, said bottom ends of said inclined ditches being open at said outwardly diverging lower end of said inner peripheral surface of said lower bearing section.

13. The rotating device as claimed in claim 1, wherein said upper and lower bearing sections are two separate member, and have the same vertical length.

14. The rotating device as claimed in claim 13, wherein said inclined ditches are formed in said inner peripheral surface of said upper bearing section, said top ends of said inclined ditches being open at said outwardly diverging upper end of said inner peripheral surface of said upper bearing section, said bottom ends of said inclined ditches being closed.

15. The rotating device as claimed in claim 13, wherein:
said inner peripheral surface of said upper bearing section further has an outwardly diverging lower end that increases downwardly and gradually in diameter; and
said inclined ditches are formed in said inner peripheral surface of said upper bearing section, said top ends of said inclined ditches being closed, said bottom ends of said inclined ditches being open at said outwardly diverging lower end of said inner peripheral surface of said upper bearing section.

16. The rotating device as claimed in claim 13, wherein:
said inner peripheral surface of said upper bearing section further has an outwardly diverging lower end that increases downwardly and gradually in diameter; and
said inclined ditches are formed in said inner peripheral surface of said upper bearing section, and includes
an upper group of said inclined ditches adjacent to an upper end of said upper bearing section, said top ends of said upper group of said inclined ditches being open at said outwardly diverging upper end of said inner peripheral surface of said upper bearing section, said bottom ends of said upper group of said inclined ditches being closed, and
a lower group of said inclined ditches adjacent to a lower end of said upper bearing section, said top ends of said lower group of said inclined ditches being closed, said bottom ends of said lower group of said inclined ditches being open at said outwardly diverging lower end of said inner peripheral surface of said upper bearing section.

17. The rotating device as claimed in claim 13, wherein:
said inner peripheral surface of said lower bearing section further has an outwardly diverging upper end that increases upwardly and gradually in diameter; and
said inclined ditches are formed in said inner peripheral surface of said lower bearing section, said top ends of said inclined ditches being open at said outwardly diverging upper end of said inner peripheral surface of said lower bearing section, said bottom ends of said inclined ditches being closed.

18. The rotating device as claimed in claim 13, wherein said inclined ditches are formed in said inner peripheral surface of said lower bearing section, said top ends of said inclined ditches being closed, said bottom ends of said inclined ditches being open at said outwardly diverging lower end of said inner peripheral surface of said lower bearing section.

19. The rotating device as claimed in claim 13, wherein:
said inner peripheral surface of said lower bearing section further has an outwardly diverging upper end that increases upwardly and gradually in diameter; and
said inclined ditches is formed in said inner peripheral surface of said lower bearing section, and includes
an upper group of said inclined ditches adjacent to an upper end of said lower bearing section, said top ends of said upper group of said inclined ditches being open at said outwardly diverging upper end of said inner peripheral surface of said lower bearing section, said bottom ends of said upper group of said inclined ditches being closed, and
a lower group of said inclined ditches adjacent to a lower end of said lower bearing section, said top ends of said lower group of said inclined ditches being closed, said bottom ends of said lower group of said inclined ditches being open at said outwardly diverging lower end of said inner peripheral surface of said lower bearing section.

20. The rotating device as claimed in claim 13, wherein:
said inner peripheral surface of said lower bearing section further has an outwardly diverging upper end that increases upwardly and gradually in diameter; and
said inclined ditches includes
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being closed, and
a lower group of said inclined ditches formed in said inner peripheral surface of said lower bearing section, said top ends of said lower group of said inclined ditches being open at said outwardly diverging upper end of said inner peripheral surface of said lower bearing section, said bottom ends of said lower group of said inclined ditches being closed.

21. The rotating device as claimed in claim 13, wherein said inclined ditches includes:
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being closed, and
a lower group of said inclined ditches formed in said inner peripheral surface of said lower bearing section, said top ends of said lower group of said inclined ditches being closed, said bottom ends of said lower group of said inclined ditches being open at said outwardly diverging lower end of said inner peripheral surface of said lower bearing section.

22. The rotating device as claimed in claim 13, wherein:
said inner peripheral surface of said upper bearing section further has an outwardly diverging lower end that increases downwardly and gradually in diameter; and
said inclined ditches includes
an upper group of said inclined ditches formed in said inner peripheral surface of said upper bearing section, said top ends of said upper group of said inclined ditches being closed, said bottom ends of said upper group of said inclined ditches being open at said outwardly diverging lower end of said inner peripheral surface of said upper bearing section and
a lower group of said inclined ditches formed in said inner peripheral surface of said lower bearing section, said top ends of said lower group of said inclined ditches being closed, said bottom ends of said lower group of said inclined ditches being open at said outwardly diverging lower end of said inner peripheral surface of said lower bearing section.

23. The rotating device as claimed in claim 13, wherein:
said inner peripheral surface of said upper bearing section further has an outwardly diverging lower end that increases downwardly and gradually in diameter;
said inner peripheral surface of said lower bearing section further has an outwardly diverging upper end that increases upwardly and gradually in diameter; and
said inclined ditches includes
an upper group of said inclined ditches formed in said inner peripheral surface of said upper bearing section, said top ends of said upper group of said inclined ditches being closed, said bottom ends of said upper group of said inclined ditches being open at said outwardly diverging lower end of said inner peripheral surface of said upper bearing section, and
a lower group of said inclined ditches formed in said inner peripheral surface of said lower bearing section, said top ends of said lower group of said inclined ditches being open at said outwardly diverging upper end of said inner peripheral surface of said lower bearing section, said bottom ends of said lower group of said inclined ditches being closed.

24. The rotating device as claimed in claim 13, wherein:
said inner peripheral surface of said upper bearing section further has an outwardly diverging lower end that increases downwardly and gradually in diameter;
said inner peripheral surface of said lower bearing section further has an outwardly diverging upper end that increases upwardly and gradually in diameter; and
said inclined ditches includes
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being open at said outwardly diverging lower end of said inner peripheral surface of said upper bearing section, and
a lower group of said inclined ditches formed in said inner peripheral surface of said lower bearing section, said top ends of said lower group of said inclined ditches being open at said outwardly diverging upper end of said inner peripheral surface of said lower bearing section, said bottom ends of said lower group of said inclined ditches being closed.

25. The rotating device as claimed in claim 13, wherein
said inner peripheral surface of said upper bearing section further has an outwardly diverging lower end that increases downwardly and gradually in diameter; and
said inclined ditches includes
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being open at said outwardly diverging lower end of said inner peripheral surface of said upper bearing section, and
a lower group of said inclined ditches formed in said inner peripheral surface of said lower bearing section, said top ends of said lower group of said inclined ditches being closed, said bottom ends of said lower group of said inclined ditches being open at said outwardly diverging lower end of said inner peripheral surface of said lower bearing section.

26. The rotating device as claimed in claim 13, wherein:
said inner peripheral surface of said upper bearing section further has an outwardly diverging lower end that increases downwardly and gradually in diameter;
said inner peripheral surface of said lower bearing section further has an outwardly diverging upper end that increases upwardly and gradually in diameter; and
said inclined ditches are formed in said inner peripheral surfaces of said upper and lower bearing sections, said top ends of said inclined ditches formed in said inner peripheral surface of said upper bearing section being open at said outwardly diverging upper end of said inner peripheral surface of said upper bearing section, said bottom ends of said inclined ditches formed in said inner peripheral surface of said upper bearing section being open at said outwardly diverging lower end of said inner peripheral surface of said upper bearing section, said inclined ditches formed in said inner peripheral surface of said lower bearing section including
an upper group of said inclined ditches adjacent to an upper end of said lower bearing section, said top ends of said upper group of said inclined ditches being open at said outwardly diverging upper end of said inner peripheral surface of said lower bearing section, said bottom ends of said upper group of said inclined ditches being closed, and
a lower group of said inclined ditches adjacent to a lower end of said lower bearing section, said top ends of said lower group of said inclined ditches being closed, said bottom ends of said lower group of said inclined ditches being open at said outwardly diverging lower end of said inner peripheral surface of said lower bearing section.

27. The rotating device as claimed in claim 13, wherein:
said inner peripheral surface of said upper bearing section further has an outwardly diverging lower end that increases downwardly and gradually in diameter;
said inner peripheral surface of said lower bearing section further has an outwardly diverging upper end that increases upwardly and gradually in diameter; and
said inclined ditches includes
an upper group of said inclined ditches formed in said inner peripheral surface of said upper bearing section, said top ends of said upper group of said inclined ditches being closed, said bottom ends of said upper group of said inclined ditches being open at said outwardly diverging lower end of said inner peripheral surface of said upper bearing section and
a lower group of said inclined ditches formed in said inner peripheral surface of said lower bearing section, said top ends of said lower group of said inclined ditches being open at said outwardly diverging upper end of said inner peripheral surface of said lower bearing section, said bottom ends of said lower group of said inclined ditches being open at said outwardly diverging lower end of said inner peripheral surface of said lower bearing section.

28. The rotating device as claimed in claim 13, wherein:
said inner peripheral surface of said lower bearing section further has an outwardly diverging upper end that increases upwardly and gradually in diameter; and
said inclined ditches includes
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being closed, and
a lower group of said inclined ditches formed in said inner peripheral surface of said lower bearing section, said top ends of said lower group of said inclined ditches being open at said outwardly diverging upper end of said inner peripheral surface of said lower bearing section, said bottom ends of said lower group of said inclined ditches being open at said outwardly diverging lower end of said inner peripheral surface of said lower bearing section.

29. The rotating device as claimed in claim 13, wherein:
said inner peripheral surface of said upper bearing section further has an outwardly diverging lower end that increases downwardly and gradually in diameter;
said inner peripheral surface of said lower bearing section further has an outwardly diverging upper end that increases upwardly and gradually in diameter; and
said inclined ditches are formed in said upper and lower bearing sections, said top ends of said inclined ditches formed in said lower bearing section being open at said outwardly diverging upper end of said inner peripheral surface of said lower bearing section, said bottom ends of said inclined ditches formed in said lower bearing section being open at said outwardly diverging lower end of said inner peripheral surface of said lower bearing section, said inclined ditches formed in said upper bearing section including
an upper group of said inclined ditches adjacent to an upper end of said upper bearing section, said top ends of said upper group of said inclined ditches being open at said outwardly diverging upper end of said inner peripheral surface of said upper bearing section, said bottom ends of said upper group of said inclined ditches being closed, and
a lower group of said inclined ditches adjacent to a lower end of said upper bearing section, said top ends of said lower group of said inclined ditches being closed, said bottom ends of said lower group of said inclined ditches being open at said outwardly diverging lower end of said inner peripheral surface of said upper bearing section.

30. The rotating device as claimed in claim 1, wherein:
said upper and lower bearing sections are formed integrally with each other, and have said same vertical length; and
said inclined ditches are formed in said inner peripheral surface of said upper bearing section, said top ends of said inclined ditches being open at said outwardly diverging upper end of said inner peripheral surface of said upper bearing section, said bottom ends of said inclined ditches being closed and located on said transverse line.

31. The rotating device as claimed in claim 1, wherein:
said upper and lower bearing sections are formed integrally with each other, and have said same vertical length; and
said inclined ditches includes
an upper group of inclined ditches formed in said inner peripheral surface of said upper bearing section, said top ends of said upper group of inclined ditches being open at said outwardly diverging upper end of said inner peripheral surface of said upper bearing section, said bottom ends of said upper group of inclined ditches being closed and located on said transverse line, and
a lower group of said inclined ditches formed in said inner peripheral surface of said lower bearing section, said top ends of said lower group of said inclined ditches being closed, said bottom ends of said lower group of said inclined ditches being open at said outwardly diverging lower end of said inner peripheral surface of said lower bearing section.

32. The rotating device as claimed in claim 1, wherein:
said upper and lower bearing sections are formed integrally with each other, and have said same vertical length; and
said inclined ditches extend from said upper bearing section into said lower bearing section, said top ends of said inclined ditches being open at said outwardly diverging upper end of said inner peripheral surface of said upper bearing section, said bottom ends of said inclined ditches being closed and located under said transverse line.

33. The rotating device as claimed in claim 1, wherein:
said upper and lower bearing sections are formed integrally with each other, and have said same vertical length; and
said inclined ditches includes
an upper group of inclined ditches extending from said upper bearing section into said lower bearing section, said top ends of said upper group of inclined ditches being open at said outwardly diverging upper end of said inner peripheral surface of said upper bearing section, said bottom ends of said upper group of inclined ditches being closed and located under said transverse line, and
a lower group of said inclined ditches formed in said inner peripheral surface of said lower bearing section, said top ends of said lower group of said inclined ditches being closed, said bottom ends of said lower group of said inclined ditches being open at said outwardly diverging lower end of said inner peripheral surface of said lower bearing section.

34. The rotating device as claimed in claim 1, wherein:
said upper and lower bearing sections are formed integrally with each other, and have said same vertical length; and
said inclined ditches are formed in said inner peripheral surface of said lower bearing section, said top ends of said inclined ditches being closed and located on said transverse line, said bottom ends of said inclined ditches being open at said outwardly diverging lower end of said inner peripheral surface of said lower bearing section.

35. The rotating device as claimed in claim 1, wherein:
said upper and lower bearing sections are formed integrally with each other, and have said same vertical length;
said inclined ditches includes:
an upper group of said inclined ditches formed in said inner peripheral surface of said upper bearing section, said top ends of said upper group of said inclined ditches being open at said outwardly diverging upper end of said inner peripheral surface of said upper bearing section, said bottom ends of said upper group of said inclined ditches being closed and located above said transverse line, and
a lower group of said inclined ditches formed in said inner peripheral surface of said lower bearing section, said top ends of said lower group of said inclined ditches being closed and located on said transverse line, said bottom ends of said lower group of said inclined ditches being open at said outwardly diverging lower end of said inner peripheral surface of said lower bearing section.

36. The rotating device as claimed in claim 1, wherein:
said upper and lower bearing sections are formed integrally with each other, and have said same vertical length; and
said inclined ditches extend from said upper bearing section into said lower bearing section, said top ends of said inclined ditches being closed and located above said transverse line, said bottom ends of said inclined ditches being open at said outwardly diverging lower ends of said lower bearing section.

37. The rotating device as claimed in claim 1, wherein:
said upper and lower bearing sections are formed integrally with each other, and have said same vertical length; and
said inclined ditches includes
an upper group of said inclined ditches formed in said inner peripheral surface of said upper bearing section, said top ends of said upper group of said inclined ditches being open at said outwardly diverging upper end of said inner peripheral surface of said upper bearing, said bottom ends of said upper group of said inclined ditches being closed and located above said transverse line, and
a lower group of said inclined ditches extending from said upper bearing section into said lower bearing section, said top ends of said lower group of said inclined ditches being closed and located above said transverse line, said bottom ends of said lower group of said inclined ditches being open at said outwardly diverging lower end of said inner peripheral surface of said lower bearing section.

38. A rotating device comprising:
a rotating shaft rotatable in a rotational direction; and
a self-lubricating bearing sleeved on said rotating shaft and having a top surface, a bottom surface, and two imaginary transverse lines which are spaced apart from each other along an axial direction of said rotating shaft and each of which extends along a transverse direction of said rotating shaft for dividing said bearing into an upper bearing section, a middle bearing section, and a lower bearing section, which are three separate members and which are arranged along said axial direction of said rotating shaft, said middle bearing section being disposed under said upper bearing section and above said lower bearing section, each of said upper and lower bearing sections having a vertical length smaller than that of said middle bearing section, an inner peripheral surface of each of said upper and lower bearing sections having an outwardly diverging upper end that increases upwardly and gradually in diameter, and an outwardly diverging lower end that increases downwardly and gradually in diameter, said bearing being formed with:
an upper group of inclined ditches formed in said inner peripheral surface of said upper bearing section and located under said top surface of said bearing, said top ends of said upper group of said inclined ditches being open at said outwardly diverging upper end of said inner peripheral surface of said upper bearing section, said bottom ends of said upper group of said inclined ditches being open at said outwardly diverging lower end of said inner peripheral surface of said upper bearing section, and
a lower group of inclined ditches formed in said inner peripheral surface of said lower bearing section and located above said bottom surface of said bearing, said top ends of said lower group of said inclined ditches being open at said outwardly diverging upper end of said inner peripheral surface of said lower bearing section, said bottom ends of said lower group of said inclined ditches being open at said outwardly diverging lower end of said inner peripheral surface of said lower bearing section, each of said upper and lower groups of said inclined ditches having top and bottom ends and extending downwardly from said top end to said bottom end in a direction corresponding to said rotational direction, said top and bottom ends of each of said upper and lower groups of said inclined ditches being spaced apart from each other by a vertical distance that is not larger than one half of a vertical length of said bearing.

39. The rotating device as claimed in claim 38, wherein each of said upper and lower groups of said inclined ditches forms an angle between 20 and 70 degrees with respect to each of said transverse line.
